(19) United States
(12) Patent Application Publication
(10) Pub. No.: US 2023/0363975 A1
(43) Pub. Date: Nov. 16, 2023

(54) TRAINING APPARATUS

(71) Applicant: SISSEL INTERNATIONAL GMBH, Bregenz (AT)

(72) Inventor: Jens FRIEBEL, Wachenheim an der Weinstraße (DE)

(21) Appl. No.: 18/025,493

(22) PCT Filed: Aug. 30, 2021
(86) PCT No.: PCT/EP2021/073884

§ 371 Date: Mar. 9, 2023

(30) Foreign Application Priority Data
Sep. 24, 2020 (AT) A 50814/2020

(51) Int. Cl. A61H 7/00; A61H 15/00

(52) U.S. Cl. CPC A61H 7/007; A61H 15/0092; A61H 2201/1284; A61H 2201/1623

(57) ABSTRACT

A training apparatus for stimulating the back muscles associated with a person's spine has two rows of shaped bodies, which run one beside the other in a longitudinal direction, in particular are not offset from one another, are connected to one another via connecting portions and project away from a base plane which runs through the connecting portions. Each shaped body has at least one bearing region, which is in the form of a bearing point or bearing surface and is intended for stimulating the back muscles, wherein the shaped bodies of the one row along with the adjacent, associated shaped bodies of the other row form respective shaped-body pairs, and wherein the shaped bodies of the shaped-body pairs form interspaces, in which portions of a spine can be accommodated in the longitudinal direction of the rows. The shaped bodies are formed monolithically together with the connecting portions.

### CROSS-REFERENCE TO RELATED APPLICATIONS

This application is the U.S. national phase of International Application No. PCT/EP2021/073884 filed Aug. 30, 2021, which designated the U.S. and claims priority to AT Patent Application No. A 50814/2020 filed Sep. 24, 2020, the entire contents of each of which are hereby incorporated by reference.

### BACKGROUND OF THE INVENTION

### Field of the Invention

The invention relates to a training apparatus for stimulating the back muscles associated with a person's spine, with two rows of shaped bodies that run next to one another in a longitudinal direction, in particular are not offset from one another, which shaped bodies are connected to one another via connecting portions and project away from a base plane that runs through the connecting portions, wherein each of the shaped bodies has at least one bearing region that is designed as a bearing point or bearing surface for stimulating the back muscles, on which a body part that surrounds the spine can be brought to rest, wherein the shaped bodies of one row along with the adjacent assigned shaped bodies of the other row that are perpendicular to the longitudinal direction form shaped-body pairs in each case, and wherein the shaped bodies of the shaped-body pairs form interspaces, in which portions of a spine can be accommodated in the longitudinal direction of the rows between the shaped bodies of the two rows that are assigned to one another.

### Description of the Related Art

Training equipment for stimulating or training back muscles is already known from DE 20 2017 000 077 U1 and WO 2019/028533 A1.

Such a training apparatus generally consists of two parallel rows of air-filled balls that are approximately of the size of tennis balls and that are connected to one another via a carrier element, such as, for example, a hose-like bag made of textile material.

During training, the training apparatus is placed under the back of a recumbent person, so that the rows of balls are arranged on either side of the spine. In the ideal case, the training apparatus runs from the back of the head to the sacrum of the person being trained. When certain exercises are being performed, the balls press on the muscles, ligaments, and tendons that run on either side of the spine, by which the latter are stimulated or stretched.

During training with such training equipment, the spine structure and the back muscles can be better discerned. In addition, when certain exercises are being performed, the training apparatus supports a mobilization of intervertebral joints. Such a training apparatus also performs a massage function on the soft tissue of the back muscles.

A disadvantage of the training equipment known from the state of the art is its complicated design, since the latter consists of individual balls, which are connected to one another via a carrier element. For example, the carrier element consists of a hose-like textile pouch, in which the balls are accommodated and sewn. Such training equipment requires a large number of operating steps in the manufacturing. In addition, it does not have great dimensional stability, since the position of the balls that are connected to one another via the carrier element can change with respect to one another during training or over an extended time, by which the quality of the training decreases and even negative training effects can occur.

In addition, it is difficult to clean conventional training equipment, since poorly accessible cracks, gaps, and inside edges are formed between the individual elements of the training apparatus, for example in the area of assembly seams.

### SUMMARY OF THE INVENTION

The object of the invention is to make available a training apparatus of the above-mentioned type that does not have the drawbacks of the state of the art. In particular, a training apparatus is to be provided that can be produced in an uncomplicated manner, can be easily and thoroughly cleaned, and has a high dimensional stability over an extended period.

This object is achieved according to the invention with a training apparatus that has the features of claim 1.

Preferred and advantageous embodiments of the invention are the subject matter of the subclaims.

According to the invention, it is provided that the shaped bodies together with the connecting portions are formed monolithically, i.e., in one piece. The shaped bodies and the connecting portions are produced essentially in a single operating step and do not need to be connected to one another in a time-consuming reworking.

Since the shaped bodies are formed integrally with the connecting portions, the shaped bodies are connected seamlessly to the connecting portions. The training apparatus thus does not have any cracks, seams, or connecting points in which dirt can collect, and can be cleaned more easily and more thoroughly than conventional training devices.

During training and over the entire service life, the training apparatus according to the invention has a high dimensional stability, since the positions of the shaped bodies relative to one another essentially cannot change or change very little—because of an optionally provided elasticity of the connecting portions. This makes extremely precise and error-free training possible permanently.

The connecting portions preferably have a web-like shape and can also be referred to as connecting webs within the framework of the invention.

The connecting portions of the training apparatus according to the invention preferably are essentially flat, i.e., flat in relation to the shaped bodies. At boundary areas between the connecting portions and the shaped bodies, the connecting portions can, however, in places increase in strength owing to curved edges, which are advantageous in molding technology.

Within the framework of the invention, a virtual plane that runs essentially centrally through the connecting portions is considered to be a base plane, wherein the base plane can also have a curvature, for example when the connecting portions are flexible. The shaped bodies preferably taper starting from the base plane to the bearing region, so that they are broader or larger in a region adjoining connecting portions than in the peripheral bearing region that is separated and projecting away from the connecting portions. The shaped bodies can taper up to a point that projects most from the base plane, for example when the shaped bodies have a spherical shape or a pyramid-like shape, wherein then a bearing region is present. It is also possible within the framework of the invention that a shaped body has several bearing regions, i.e., several bearing regions that are separated from the base plane with essentially the same width.

It is provided within the framework of the invention that the training apparatus has two rows of shaped bodies. Embodiments with more than two rows of shaped bodies, i.e., embodiments that in addition to the two rows also have additional rows of shaped bodies, also fall under the scope of protection of the invention, however. In such embodiments, the training apparatus according to the invention has in particular a specific number of rows, for example four, six, eight, or more than eight rows.

In a preferred embodiment, each of the rows has at least two, preferably at least eight, shaped bodies. The training apparatus can have, for example, ten, twelve, fourteen, sixteen, or more than sixteen shaped bodies per row. The number of shaped bodies is preferably adapted to the number of cervical or dorsal vertebrae of a human, so that the training apparatus runs from the neck region up to the sacral region of a recumbent person.

Within the framework of the invention, the shaped bodies can project away from the base plane on either side or on one side. In embodiments in which the shaped bodies project away from the base plane on either side, the base plane runs preferably centrally through the shaped bodies, so that the latter are made symmetric to the base plane and project away from the latter symmetrically. These two-sided embodiments ensure that the massage apparatus can be used on either side, and because of the two-sided bearing points, a person using the training apparatus no longer has to pay attention to which side is facing the back. Moreover, the shaped bodies are supported on certain points on a support. As a result, practical, especially advantageous flexibility and deformability are provided, thus ensuring that the shaped bodies can be moved more flexibly relative to one another. Thus, molding the training apparatus to the individual structure of the spine and musculature of a person is also ensured. A lever action between the bearing points and on the support and on the base plane makes this possible. For this lever action, the training apparatus must be in one piece. A flat bearing surface or even using tennis balls do not make this possible.

In particular, within the framework of the invention, an embodiment is preferred in which the shaped bodies are designed to be spherical bodies and essentially ball-shaped and project away from the base plane on either side. Training equipment that is formed in such a way can be used in an especially versatile manner since it can be used on either side.

Within the framework of the invention, the shaped bodies can, however, also be designed to be essentially hemispherical and project away from the base plane on one side. In such an embodiment, the flat connecting portions form an essentially flat bearing surface together with essentially flat bottoms of the shaped bodies on any side away from which the shaped bodies do not project, so that the training apparatus can be placed in an especially stable manner on a flat base.

A similarly more positive effect is achieved when the shaped bodies project away from the base plane on either side, but are not rounded on the side that is not to be facing the body in the operating position, but rather have a straight bearing surface. In this case, the shaped bodies can be partially spherical or else approximately pyramidal.

Preferred are embodiments in which the shaped bodies are arranged in any row that is essentially not offset next to the shaped bodies of the adjoining row. This means that adjacent shaped bodies are arranged in two rows that, viewed from the side, are directly behind one another and are not offset relative to one another. Each shaped body is thus arranged only close to an individual shaped body of the adjacent row but further away from the other shaped bodies of the adjacent row. The rows can also be referred to as being arranged essentially symmetrically or parallel. Such an arrangement of shaped bodies is especially advantageous since the muscles, ligaments, and tendons as a rule are also arranged symmetrically on either side of the spine.

Preferred are embodiments in which each of the shaped bodies is connected to the adjacent shaped body or the adjacent shaped bodies of the same row via one connecting portion respectively and/or the shaped bodies of each shaped-body pair are connected via one connecting portion respectively, and/or each of the shaped bodies of each shaped-body pair is connected to the shaped body of the other row of the adjacent shaped-body pair or the shaped bodies of the other row of the adjacent shaped-body pairs via one connecting portion respectively. These ways of arranging the connecting portions are not exclusive but rather can be implemented simultaneously, wherein the connecting portions can merge into one another seamlessly or can be connected to one another.

As a connecting portion, two- or one-dimensional connecting spots, such as connecting surfaces or connecting points, are also considered to fall within the framework of the invention. For example, the shaped bodies can be connected directly to one another, so that the connecting portions on the connecting surfaces that run between the shaped bodies are reduced. When the shaped bodies are connected to one another only at points, the connecting points or pointlike connecting surfaces between the shaped bodies are considered to be connecting portions within the framework of the invention.

Within the framework of the invention, forms of further development are also conceivable in which the connecting portions transition into one another seamlessly such that an individual, common connecting element is thus formed. Such a common connecting element can have, for example, a through opening in each case in the regions between two successive shaped bodies of one row and the shaped bodies of the adjoining row arranged next to these shaped bodies. As a result, an especially stable connection of the shaped bodies can be ensured and at the same time, material can be saved, so that the training apparatus is lighter and easier to handle. When connecting portions are mentioned in this description of the invention, these declarations also apply to an individual common connecting element. In particular, the individual, common connecting element can have all the features of the connecting portions described within the framework of this invention.

In an especially advantageous embodiment, it is provided that the connecting portions and the shaped bodies that are thus integrally formed have a closed-pore outside layer. Such a training apparatus can be easier to clean and is more robust.

Within the framework of the invention, it is preferred when the shaped bodies and the connecting portions are formed from a plastic. In particular, it is preferred when a plastic that is elastically or highly elastically deformable at least in regions of smaller thickness is used. As a result, a training apparatus can be produced that can be bent in the region of the connecting portions to a certain extent and nevertheless retains a high dimensional stability during training.

The shaped bodies and the connecting portions preferably consist of a thermoplastic polymer, silicone, or a natural or synthetic rubber. The shaped bodies and the connecting portions especially preferably consist of a PUR (polyurethane) integral foam.

In particular, it is provided within the framework of the invention that the shaped bodies and the connecting portions are foamed, injection-molded, or cast in one piece. The shaped bodies and the connecting portions are especially preferably produced using the RIM (reaction injection molding) or RRIM (reinforced reaction injection molding) method. These production methods allow the simple production of qualitatively high-grade training devices according to the invention with a large number of units.

Within the framework of the invention, it can be provided that on the inside, the shaped bodies have a hollow space or several hollow spaces. The presence of hollow spaces saves material and thus costs and weight. Within the framework of the invention, it is also conceivable that the hollow spaces of the shaped bodies are connected via hollow spaces formed in the connecting portions or-in the case that the connecting portions form an individual, common connecting element-via a hollow space formed in the connecting element.

Within the framework of the invention, embodiments in which the shaped bodies do not have any hollow space or spaces and are embodied solidly over their entire volume are, of course, also possible, since the latter can be produced especially easily.

In embodiments with hollow spaces, the latter can be filled with a filler, preferably with a gas, for example air, a liquid, a granular material, or a solid. As a result, light or elastically springy training equipment can be produced, which has an adequate size, an acceptable weight, and high dimensional stability, wherein its outside layer is as smooth and resilient as possible. The hollow spaces are especially preferably filled with a foamed plastic, preferably polyurethane. The filler, depending on the desired “degree of hardness” of the training apparatus, can, for example, be foamed to a greater or lesser extent and thus have larger or smaller pores or gas inclusions. Such a plastic that is used as filler can be compressed at various levels of strength depending on the pore size or its material properties, so that within the framework of the invention, training equipment of varying “hardness” or elasticity can be produced.

Within the framework of the invention, it can be provided in particular that the material of the filler has a smaller density than the material of the shaped bodies, in particular that the material of the shaped bodies is closed-pore and the material of the filler has gas inclusions or is more open-pore than the material of the shaped bodies.

Within the framework of the invention, embodiments of the training apparatus in which the shaped bodies have hollow spaces and the hollow spaces of at least two of the shaped bodies are filled with a material that is different from the other hollow spaces are also possible. In such training equipment, the shaped bodies, depending on the region of the spine in which they are arranged during use, have different properties with respect to their strength, elasticity, and spring action.

It is especially preferred when the distance between shaped bodies of each shaped-body pair is between 30 mm and 100 mm, in particular between 40 and 80 mm, preferably between 45 and 65 mm. This ensures that there is enough space for accommodating the vertebrae of the spine of a person being trained with the training apparatus. In the case of a smaller distance between shaped bodies, the vertebrae do not have enough space between the shaped bodies because of the patient's spinal processes directed backwards toward the training apparatus. In the case of a greater distance between shaped bodies, the spine is not supported adequately, and the muscles engaging the spine cannot be stimulated in the region of their contact points on the spine. In both cases, the training is uncomfortable for the person being trained with the training apparatus, and the training effect is significantly reduced.

The distance between adjacent shaped bodies in each of the rows is preferably between 30 mm and 100 mm, in particular between 40 and 80 mm, preferably between 45 and 65 mm. As a result, adequate space is formed between the shaped bodies for accommodating the perpendicular extensions of the vertebrae, so that the training can be carried out as comfortably and effectively as possible.

Within the framework of the invention, the shaped bodies can in each case have at least one bearing region, i.e., the shaped bodies can have at least one bearing region projecting away from the connecting portion on either side of the connecting portion (“above and below”) or on only one side of the connecting portion (“only above”). Within the framework of the invention, shaped bodies can have a projection or two or more than two projections, which in each case forms/form a bearing region.

Within the framework of the invention, the expression “at least one part” is defined as that one part or two parts or more than two parts can be present.

### BRIEF DESCRIPTION OF THE DRAWINGS

Additional details, features, and advantages of the invention are given in the description below with reference to the accompanying drawings, in which preferred embodiments are depicted. Here:

FIG. 1 shows a diagrammatic top view of a training apparatus according to the invention, wherein shaped bodies and connecting portions arranged according to a first embodiment are depicted as separate, partially overlapping bodies,

FIG. 2 shows a diagrammatic top view of the training apparatus according to FIG. 1, with shaped bodies and connecting portions depicted connected to one another but without exposed edges,

FIGS. 3 to 8 show additional diagrammatic top views as in FIGS. 1 and 2 in another three embodiments of the training apparatus according to the invention with differently arranged connecting portions respectively, in each case with shaped bodies and connecting portions depicted separated and connected,

FIG. 9 shows a top view of an embodiment of the training apparatus according to the invention, in which the connecting portions merge into one another seamlessly and form an individual, common connecting element,

FIG. 10 shows a side view of the training apparatus according to the invention according to FIG. 9, wherein a shaped body of the training apparatus is shown as a partial cutaway-along an angled sectional plane X-X,

FIG. 11 shows a top view of a training apparatus according to the invention according to another embodiment with a common connecting element, and

FIG. 12 shows a side view of the training apparatus according to the invention according to another possible embodiment.

### DESCRIPTION OF THE PREFERRED EMBODIMENTS

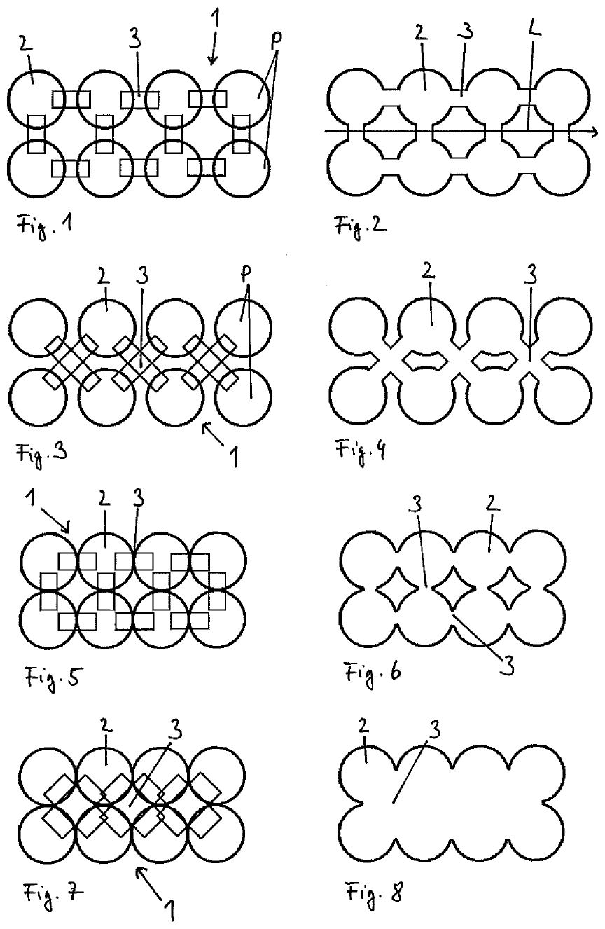

FIGS. 1 to 8 show a very diagrammatic top view of a training apparatus 1 according to the invention with two rows of shaped bodies 2 that are arranged next to one another, which shaped bodies are spherical in the depicted embodiment. The rows run in a longitudinal direction L.

In each case, a shaped body 2 of one row is assigned to an adjacent shaped body 2, not offset, of the other row, so that these two shaped bodies 2 form a shaped-body pair P.

The shaped bodies 2 are connected to one another via flat connecting portions 3 and are formed monolithically or integrally with the latter.

In FIGS. 1 to 8, only four shaped bodies 2 respectively are depicted in each of the rows. This means, however, that this number of shaped bodies 2 is only intended as an example. The training apparatus 1 according to the invention preferably has more than four, for example six to fourteen, shaped bodies 2 per row.

In FIGS. 1, 3, 5, and 7, the shaped bodies 2 and the connecting portions 3 are depicted respectively—to ensure better understanding—as separate bodies, overlapping in certain regions, and in FIGS. 2, 4, 6, and 8, they are depicted as connected to one another.

In FIGS. 1 and 2, a first embodiment is depicted, in which the shaped bodies 2 are separated from one another and thus form an interspace, and each shaped body 2 is connected to the adjacent shaped body 2 (in the case of a shaped body 2 arranged on one end of the training apparatus 1) or the adjacent shaped bodies 2 of the same row, as well as the respectively assigned shaped body 2 of the same shaped-body pair P, via one connecting portion 3 respectively.

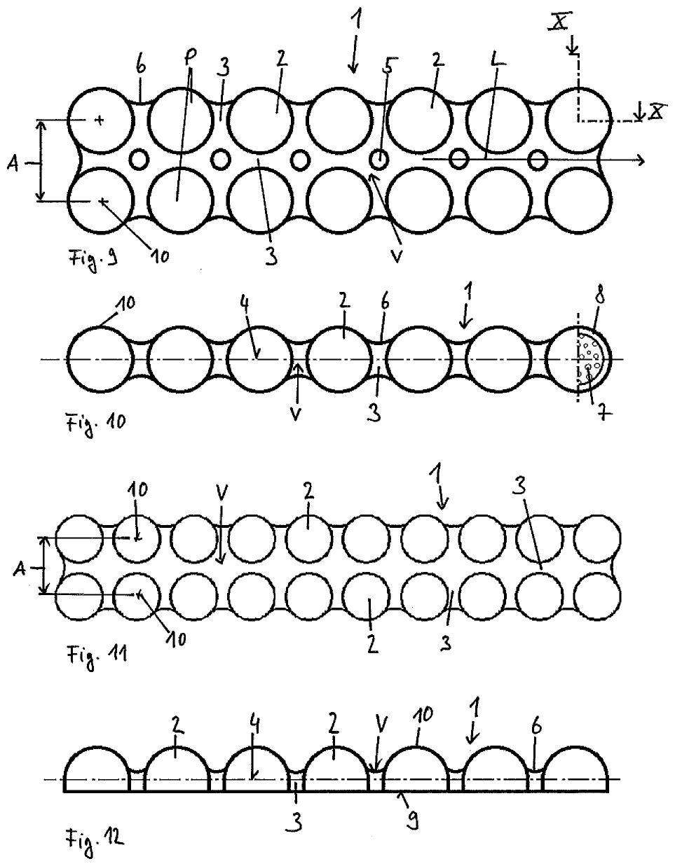

In FIGS. 3 and 4, an additional possible embodiment of the training apparatus 1 according to the invention is depicted, in which the shaped bodies 2 are separated from one another, and each shaped body 2 is connected to the shaped body 2 of the other row of the adjacent shaped-body pair P (in the case of a shaped body 2 that is arranged on one end of the training apparatus 1) or the adjacent shaped bodies 2 of the other row of the adjacent shaped-body pair P.

In FIGS. 5 and 6, another possible embodiment of the training apparatus 1 according to the invention is depicted, in which the shaped bodies 2 are directly adjacent, so that the diagrammatically depicted connecting portions 3 are reduced to the connecting regions that are almost indistinguishable from the shaped bodies 2 or the connecting surfaces that run between the shaped bodies 2.

In FIGS. 7 and 8, still another embodiment of the training apparatus 1 according to the invention is depicted, in which the shaped bodies 2 are also directly adjacent. In this embodiment, the connecting portions 3 that are depicted diagrammatically as intersecting run into one another seamlessly, so that in each case, the regions that are surrounded by two adjacent shaped-body pairs P are bridged entirely by the connecting portions 3.

FIG. 9 shows another possible embodiment of the training apparatus 1 according to the invention, in which the shaped bodies 2 are separated from one another, and the connecting portions 3 form an individual, common connecting element V, since they merge into one another seamlessly.

FIG. 10 shows the training apparatus according to FIG. 9 in a side view, wherein it can be seen that in the depicted embodiment, the rows of shaped bodies 2 run essentially parallel, so that two adjacent shaped bodies 2, assigned to one another, of different rows, which form a shaped-body pair P, are arranged directly behind one another, seen from the side.

A base plane 4, away from which the spherical shaped bodies 2 project symmetrically, runs centrally through the essentially flat connecting portions 3—or through the individual, common connecting element V.

Between two adjacent shaped-body pairs P respectively, the common connecting element V has through openings 5, or the connecting portions 3 that run into one another in places surround through openings 5. These through openings 5 are depicted as circular in FIG. 1, but can also be oval, square, star-shaped, or of some other shape.

In the depicted embodiment, in many transition regions, which form a transition between the common connecting element V and the shaped bodies 2, the flat common connecting element V is-or the connecting portions 3 are-rounded on the outside edge, so that in these regions, curved edges 6 are formed that face into the interior of the common connecting element V. The training apparatus 1 thus does not have any sharp corners in which dirt could collect or whose presence could have a negative effect on the manufacturing of the training apparatus 1—for example by casting. Within the framework of the invention, however, embodiments with fewer, more, smaller, larger, or even no curved edges 6 are also conceivable.

In FIG. 10, one of the shaped bodies 2 is depicted partially in cutaway, wherein the section runs along a sectional plane X-X drawn in FIG. 1.

The cutaway depiction shows that in the depicted embodiment of the training apparatus 1 according to the invention, hollow spaces 7 are formed in the shaped bodies 2. The hollow spaces 7 are filled with a porous material that has properties that are different from those of the material from which the shaped bodies 2 and the connecting portion 3 or the common connecting element V are formed and that forms a closed-pore outside layer 8.

In FIG. 11, another possible embodiment of the training apparatus 1 according to the invention is depicted in a top view in which the training apparatus 1 does not have any through openings 5 in the common connecting element V. In addition, each row consists of ten shaped bodies 2 instead of seven shaped bodies 2 as in FIGS. 9 and 10.

In FIG. 12, still another possible embodiment of the training apparatus 1 according to the invention is depicted in a side view. In this embodiment, the shaped bodies 2 are essentially hemispheres, so that on only one side of the base plane 4, they project away from the latter and the connecting portions 3 or—if present—the common connecting element V. On the other side of the base plane 4, essentially flat bottoms of the shaped bodies 2 together with the connecting portions 3 or optionally the common connecting element V form a flat bearing surface 9.

It is understood that the shaped bodies 2 of the training equipment 1 according to FIGS. 1 to 8, 11 and 12, can also have a hollow space 7, with or without fill material accommodated within. In the same manner, the shaped bodies according to FIGS. 1 to 10 can be designed to be hemispherical as in FIGS. 11 and 12.

The connecting portions 3 depicted in FIGS. 1 to 4 can be made narrower than depicted. In addition, the connecting portions 3 can be also be made wider than depicted and can run into one another seamlessly in places.

Each shaped body 2 has at least one region that is located further from the base plane 4 than the other regions of the shaped body 2. Within the framework of the invention, this region is referred to as the bearing region 10, since to this end, it is suitable for serving as a support for the body parts of a person undergoing training and surrounding the spine and in this case for exerting pressure on the musculature of the spine of the person being trained with the training apparatus 1. When the shaped bodies 2 project away on either side of the base plane 4, each shaped body 2 can have, for example, two such bearing regions 10, so that the training apparatus 1 has on either side a bearing side for the body parts of a person being trained.

The bearing regions 10 can assume essentially the shape of points when the shaped bodies 2 taper more and more away from the base plane 4, such as, for example, in the case of a ball shape or pyramidal shape. In the case of such shaped bodies 2, the bearing region 10 becomes a bearing point.

Between the bearing regions 10 or the bearing points or surface centers of gravity of the bearing regions 10 of the two shaped bodies 2 of a shaped-body pair P, a distance A is formed. The distance A is great enough to form an interspace in which portions of the spine of a person being trained with the training apparatus 1 can be accommodated in the longitudinal direction L between the shaped bodies 2. Preferably, this distance A is between 40 and 80 mm in size.

Within the framework of the invention, the following features that are listed by way of example can be combined with one another arbitrarily: the number of rows of shaped bodies 2, the number of shaped bodies 2 in the rows, the shape of the shaped bodies 2 (for example, spherical or pyramidal-shaped), the further configuration of the shaped bodies 2 (e.g., size and/or material of the shaped bodies 2 and/or the presence of hollow spaces and the filling thereof), as well as various embodiments of the connecting portions 3 (e.g., as common connecting element V, as well as with or without through openings 5 and/or curved edges 6).

### REFERENCE SYMBOL LIST

1 Training apparatus
2 Shaped body
3 Connecting portion
4 Base plane
5 Through opening
6 Curved edge
7 Hollow space
8 Outside layer
9 Bearing surface
10 Bearing region
L Longitudinal direction
P Shaped-body pair
V Common connecting element
A Distance between bearing regions (bearing points) of a shaped-body pair

1. Training apparatus for stimulating the back muscles associated with a person's spine, with two rows of shaped bodies that run next to one another in a longitudinal direction, which shaped bodies are connected to one another via connecting portions and project away from a base plane that runs through the connecting portions, wherein each of the shaped bodies has at least one bearing region that is designed as a bearing point or bearing surface for stimulating the back muscles, wherein the shaped bodies of one row along with the adjacent assigned shaped bodies of the other row that are perpendicular to the longitudinal direction form shaped-body pairs in each case, and wherein the shaped bodies of the shaped-body pairs form interspaces, in which portions of a spine can be accommodated in the longitudinal direction of the rows, wherein the shaped bodies together with the connecting portions are formed monolithically.

2. The training apparatus according to claim 1, wherein the connecting portions have a web-like shape.

3. The training apparatus according to claim 1, wherein each of the rows has at least two shaped bodies.

4. The training apparatus according to claim 1, wherein the shaped bodies project away from the base plane on either side, or on one side.

5. The training apparatus according to claim 1, wherein the shaped bodies are spherical bodies.

6. The training apparatus Training apparatus according to claim 5, wherein the shaped bodies that are designed as spherical bodies are designed to be essentially spherical or partially spherical and project away from the base plane on either side or are designed to be hemispherical and project away from the base plane on one side.

7. The training apparatus according to claim 1, wherein each of the shaped bodies is connected to the adjacent shaped body or the adjacent shaped bodies of the same row via one connecting portion respectively and/or wherein the shaped bodies of each shaped-body pair are connected via one connecting portion respectively and/or wherein each of the shaped bodies of each shaped-body pair is connected to the shaped body of the other row of the adjacent shaped-body pair or the shaped bodies of the other row of the adjacent shaped-body pairs via one connecting portion respectively.

8. The training apparatus according to claim 1, wherein the connecting portions transition into one another seamlessly such that an individual, common connecting element is formed, wherein the common connecting element preferably in regions surrounded by two successive shaped body pairs in each case has a through opening.

9. The training apparatus according to claim 1, wherein the monolithically-formed shaped bodies together with the connecting portions have a closed-pore outside layer-.

10. The training apparatus according to claim 1, wherein the shaped bodies and the connecting portions are formed from a plastic, from silicone, or from rubber.

11. The training apparatus according to claim 1, wherein the shaped bodies and the connecting portions are foamed, injection-molded, or cast in one piece.

12. The training apparatus according to claim 1, wherein on the inside, the shaped bodies enclose a hollow space or several hollow spaces.

13. The training apparatus according to claim 12, wherein the hollow spaces are filled with a filler.

14. The training apparatus according to claim 13, wherein the material of the filler has a lower density than the material of the shaped bodies.

15. The training apparatus according claim 1, wherein the distance between the bearing regions or the bearing points or surface centers of gravity of the bearing regions of the shaped bodies of each shaped-body pair is between 30 mm and 100 mm.

16. The training apparatus according to claim 1, wherein a longitudinal distance between bearing regions or the bearing points or surface centers of gravity of the bearing regions of the adjacent shaped bodies inside the rows is between 30 mm and 100 mm.

17. The training apparatus according to claim 1, wherein the shaped bodies project away from the base plane on either side, symmetrically.

18. The training apparatus according to claim 1, wherein the connecting portions transition into one another seamlessly such that an individual, common connecting element is formed, wherein the common connecting element, in regions surrounded by two successive shaped-body pairs, in each case has a through opening.

19. The training apparatus according to claim 1, wherein the distance between the bearing regions or the bearing points or surface centers of gravity of the bearing regions of the shaped bodies of each shaped-body pair is between 40 mm and 80 mm.

20. The training apparatus according to claim 1, wherein the distance between the bearing regions or the bearing points or surface centers of gravity of the bearing regions of the shaped bodies of each shaped-body pair is between 45 mm and 65 mm.
